(19) United States
(12) Patent Application Publication
(10) Pub. No.: US 2022/0000093 A1
(43) Pub. Date: Jan. 6, 2022

(54) APPLICATOR FOR PESTICIDES

(71) Applicant: Bayer CropScience LP, St. Louis, MO (US)

(72) Inventors: Alexander KO, Durham, NC (US); Byron REID, Raleigh, NC (US); David A. CLEMENS, Chapel Hill, NC (US); Wilson Christopher LAMB, Hillsborough, NC (US); Michelle H. DEMERS, Holly Springs, NC (US); Paul STAPLETON, Apex, NC (US); Spencer MOUGEY, Raleigh, NC (US)

(21) Appl. No.: 17/425,860

(22) PCT Filed: Dec. 11, 2019
(86) PCT No.: PCT/US2019/065753

§ 371 Date: Jul. 26, 2021

Related U.S. Application Data
(60) Provisional application No. 62/797,634, filed on Jan. 28, 2019.

(51) Int. Cl. A01M 7/00; A01M 1/20; A01M 25/00; A01M 1/04

(52) U.S. Cl. CPC A01M 7/0089; A01M 1/2055; A01M 7/0032; A01M 2200/01; A01M 25/006; A01M 1/04; A01M 7/0085

(57) ABSTRACT

A product applicator assembly including a housing having a first end and a second end;

a dispensing force; a dispensing device operatively attached to the dispensing force; at least one power source; a dispensing switch operatively attached to the dispensing force; a data operator electrically connected to an electrical power source. Also provided is a bait applicator and a method of using the applicator to apply bait.

### FIELD OF USE

The invention relates generally to the structure and use of applicators for substances, such as, pesticides, more particularly to applicators using external cartridges and still more particularly to applicators having trigger activated pump motors.

### BACKGROUND

Pesticides such as insecticides, herbicides, and fungicides as well as other chemicals are often applied to specific smaller targets as well as large fields. In the former situation, hand-held applicators can be used to bring the product close to the target and apply a quantity of chemical product to the target. Products in the form of a gel may be applied in this way using cartridges containing the product that are attached to the applicators.

Prior applicators often have disadvantages such as not being designed to avoid under- or over-application of pesticide, not delivering a controlled amount of substance, and/or difficulty in applying the correct amount of substance, resulting in product waste, increased product cost, or over use. Moreover, they often do not enable tracking of the amount of product remaining in the cartridges.

Mechanical pumping mechanisms are often complex and expensive. They are often prone to failure, or require specialist mechanical expertise to service, maintain or to repair. This complicates both business operations for the user and risks pest management effectiveness in the event of failure during the application or number of applications performed by the applicator.

One such applicator is seen in U.S. Pat. No. 9,616,400 to Rahm. Rahm discloses a mechanical driving device for an applicator that is configured to hold two separate product cartridges and provides a mixing chamber where the two products can be mixed when the device is activated. The applicator includes a detector that detects counter pressure which builds up during product discharge and a control function that reads the pressure build up. However, the applicator has several mechanical parts including a transmission for a drive motor that possesses the disadvantage of a mechanical applicator discussed above.

U.S. Pat. No. 6,268,000 to Romer discloses a pastry dough or cake decorating device. Although the device includes a nozzle for directing the discharge of dough or cake icing, it has no way to precisely measure product dispensed or product remaining in the device.

U.S. Pat. No. 5,503,307 to Wilson, et al. discloses a quick release caulking gun that possesses an electric motor that drives the plunger when it pushes caulking out of the cartridge. However, the Wilson disclosure uses a complicated array of gear tracks and gears to drive the plunger and provides no method to measure how much bait product has been dispensed or remains in the product cartridge. The complicated set up is expensive to manufacture and costly in terms of labor and parts to maintain.

U.S. Pat. No. 4,335,834 to Zepkin discloses a caulking gun in which the plunger is driven by an electric motor. However, there is no method of dispensing a known quantity of product or determining a precise quantity of material remaining in a partially empty cartridge.

U.S. Patent Application Publication No. 2009/0101673 to Alioto, et al. discloses a fluid extruding device that includes a motor with an elongated screw connected to pushing plates that push product from two cartridges simultaneously through a single nozzle. The drive motor is positioned under the cartridges thereby requiring the elongated screw to extend back toward pushing shafts. The mechanical pushing action thus is required to be forced into two opposing directions necessitating a complex gearing configuration. In addition, the Alioto device makes no provision for control of the amount of caulking dispensed and determining how much product remains in the used cartridges.

U.S. Patent Application No. 2013/0020350 to Gardos et al., discloses a gun-shaped applicator with a drive motor positioned under the drive mechanism that pushes the product out of the syringe or cartridge holding the product. Like the Alioto applicator, the Gardos applicator utilizes a series of gears to reverse the initial motor drive toward the back end of the applicator to drive a piston toward the product syringe.

There is a need in the field for an improved applicator to dispense product from an attached product cartridge.

### SUMMARY

An embodiment of the present invention is related to a product applicator assembly (“applicator”) comprising a housing having a first end and a second end; a dispensing force; a dispensing device operatively attached to the dispensing force; at least one power source, at least one of which is an electrical power source; a dispensing switch operatively attached to the dispensing force; and, at least one data operator electrically connected to the electrical power source. In one embodiment, the product is contained in a releasably attached product container. In the same or an additional embodiment, the product may be any type of pesticide bait such as a gel-based pesticide, an aqueous based pesticide, or an organic pesticide, including an insecticide bait. Other products may also be dispensed from the product applicator assembly.

In one embodiment of the assembly, the applicator includes: a housing having a first end, a second end and a handle; a dispensing force in the form of a stepper motor positioned at the first end of the housing; a dispensing device in the form of a plunger assembly operatively attached to the stepper motor; a power source in the form of a battery pack electrically connected to at least one circuit board; an on/off switch supported on the first circuit board; a dispensing switch in the form of a trigger supported by the at least one circuit board and operatively attached to the stepper motor; and a home button attached to the first circuit board. The applicator includes one or more data operators electrically connected to the battery pack. The data operator(s) may be, but is not limited to a data screen, an RFID antenna, RFID tags, and smart phones. The plunger assembly may extend through the RFID antenna.

In an embodiment, the data operator may be an app that controls the applicator.

In an embodiment, the applicator includes a cartridge possessing an RFID tag and the cartridge is releasably attached to the second end of the housing. In another embodiment, the applicator further includes an aiming light.

An embodiment of the invention also includes a method of applying product. i.e., a method of use of the applicator, that includes releasably attaching a cartridge onto the applicator assembly; activating the dispensing switch to activate the dispensing force; moving the dispensing device into the cartridge; and, ejecting the product toward the target.

An embodiment of the invention further includes a method of applying a product using the applicator that includes the steps of: releasably attaching a cartridge onto the applicator; wherein the cartridge contains bait product; aiming the first end of the applicator toward a target; pulling the dispensing switch of the applicator; activating the dispensing force of the applicator; moving the dispensing device toward the attached cartridge; and ejecting the bait product toward the target. The cartridge may include a data operator.

In certain embodiments, an advantage of the applicator is that it can provide a known quantity of bait onto a product.

In certain embodiments, an advantage of the applicator is that it can be adjustably used to apply different quantities of bait product onto a target.

In certain embodiments, another advantage of the applicator is that it can deliver data regarding bait product usage and quantity of bait or other product remaining in the cartridge.

Further embodiments of the present invention are:
1. A product applicator comprising:
a housing having a first end and a second end;
a dispensing force;
a dispensing device operatively attached to the dispensing force;
at least one power source;
a dispensing switch operatively attached to the dispensing force; and,
at least one data operator electrically connected to an electrical power source.
2. The applicator of embodiment 1 further comprising a product cartridge releasably attached to the housing.
3. The applicator of any of the preceding embodiments wherein the electrical connection is at least one circuit board.
4. The applicator of any of the preceding embodiments, further comprising a handle attached to or integral with the housing.
5. The applicator of any of the preceding embodiments wherein the at least one power source is an electrical power source.
6. The applicator of any of the preceding embodiments wherein the at least one power source is a battery or battery pack.
7. The applicator of any of the preceding embodiments wherein the at least one data operator is chosen from an app, a data screen, a dispensing switch, an on/off switch, an RFID antenna, an RFID tag, a computer, a server, a smart phone, a laptop, or any combination thereof.
8. The applicator of any of the preceding embodiments wherein the dispensing device is operatively connected to the cartridge.
9. The applicator of any of the preceding embodiments wherein the dispensing force is chosen from a spring, a push rod, a threaded rod, a motor, a stepper motor, and any combination thereof.
10. The applicator of any of the preceding embodiments wherein the dispensing device is chosen from a rod, a plunger assembly, threaded rod, pump, or any combination thereof.
11. The applicator of any of the preceding embodiments wherein the dispensing switch is chosen from a push button, a lever, a knob, trigger or any combination thereof.
12. The gel bait applicator according to embodiment 1 further comprising:
at least one circuit board;
a load/unload switch;
an on/off switch supported on said at least one circuit board;
a dispensing trigger supported by said at least one circuit board and operatively attached to said dispensing device; and,
a battery pack electrically connected to said first circuit board;
wherein said applicator is controlled by a first data operator in the form of an app running on a mobile device;
wherein the housing further comprises a handle;
wherein the dispensing force is a stepper motor;
wherein the dispensing device is a plunger assembly operatively attached to said stepper motor;
wherein the dispensing switch is a trigger supported by said at least one circuit board; and.
wherein the power source is a battery pack electrically connected to said at least one circuit board.
   13. The gel bait applicator of any one of the preceding embodiments further comprising a second data operator in the form of an RFID antenna functionally attached to said applicator.
   14. The gel bait applicator according to any of the preceding embodiments further comprising a cartridge releasably attached to said applicator.
   15. The gel bait applicator of embodiment 14 wherein said cartridge includes a third data operator in the form of an RFID tag.
   16. The gel bait applicator of any one of the preceding embodiments wherein said RFID antenna reads said RFID tag.
   17. The gel bait applicator of any one of the preceding embodiments further comprising an aiming light.
   18. The gel bait applicator of any one of the preceding embodiments wherein said battery pack is located in said handle of said housing.
   19. The gel bait applicator of any one of the preceding embodiments wherein said power source is removable.
   20. The gel bait applicator of any one of the preceding embodiments wherein said power source is rechargeable.
   21. The gel bait applicator of the embodiment 12 wherein said plunger assembly includes
   a plunger;
   a plunger nut attached to plunger; and,
   a lead screw attached to said stepper motor and attached to said plunger nut.
   22. The gel bait applicator of the embodiment 21 wherein said lead screw extends into said plunger.
   23. The gel bait applicator of any one of the preceding embodiments further comprising a home button.
   24. The gel bait applicator of any one of the preceding embodiments further comprising a data screen mounted on said applicator and configured to display data received from said app.
   25. A method of applying a product onto a target using the applicator of any of the above embodiments, comprising:
   releasably attaching a cartridge onto the applicator assembly;
   activating the dispensing switch to activate the dispensing force;
   moving the dispensing device into the cartridge;
   ejecting the product toward the target; and,
   recording an application of said product one said target by at least one of said data operator.
   26. A method of applying a product onto a target using the applicator of embodiment 12, comprising:
synchronizing said app with said applicator;
releasably attaching a cartridge onto said applicator wherein said cartridge contains a bait product;
recording cartridge information into said app;
extending said plunger to said cartridge using a load mode on said load/unload button;
recording a remaining quantity of said bait product in said cartridge;
aiming the first end of said applicator toward a target;
pulling the trigger of said applicator;
activating the stepper motor of the applicator;
pushing the plunger assembly toward the attached cartridge; and
ejecting said bait product toward said target.
   27. The method of embodiment 25 wherein said applicator further comprises a data screen wherein said data screen is configured to display data received from said app.
   28. The method of any one of embodiments 25-27 wherein said applicator further comprises an RFID antenna and said cartridge include an RFID tag.
   29. The method of any one of embodiments 25-28 further comprising repeating said recording, aiming, pulling activating, pushing and ejecting steps.
   30. The method of any one of embodiments 25-29 further comprising indicating a job complete status via said app.
   31. The method of any one of embodiments 25-30 further comprising retracting said plunger assembly to a default position after synchronizing said app with said applicator.
   32. The method of any one of embodiments 25-31 further comprising illuminating said target with an aiming light.
   33. The method of any one of embodiments 25-32 further comprising transmitting a bait identification data and amount of said bait product applied to a server via said app.
   34. Use of an applicator of any of the above embodiments for applying a bait product comprising:
releasably attaching a cartridge onto said applicator;
pulling said trigger to activate said stepper motor;
pushing said plunger assembly into said cartridge; and,
ejecting said product toward said target.

### BRIEF DESCRIPTION OF THE SEVERAL VIEWS OF THE DRAWINGS

The nature and mode of the operation of the present invention will now be more fully described in the following detailed description of an embodiment of the invention taken with the accompanying drawing Figures, in which:

FIG. 1 is a side perspective view of a bait applicator of the present invention;

FIG. 2 is a top view of the applicator;

FIG. 3 is a front view of the applicator of the present invention depicting a bait loaded cartridge attached to the applicator at the front end;

FIG. 4 is a side view of the cartridge showing an RFID tag and one embodiment of a retaining means used to attach the cartridge to the applicator;

FIG. 5 is a cross section view of the applicator taken along line 5-5 in FIG. 2;

FIG. 6 is an exploded top perspective view of an applicator of the present invention: and,

FIG. 7 is flow diagram depicting a method of operation of the applicator of the present invention

### DETAILED DESCRIPTION OF EMBODIMENTS OF THE INVENTION

At the outset, it should be appreciated that like drawing numbers on different drawing views identify identical structural elements of the invention. It also should be appreciated that figure proportions and angles are not always to scale in order to clearly portray the attributes of the present invention.

While the present invention is described with respect to what is presently considered to be preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only and is not intended to limit the scope of the present invention, which is limited only by the appended claims.

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. Although any methods, devices or materials similar or equivalent to those described herein can be used in the practice or testing of the invention, the preferred methods, devices, and materials are now described.

The applicator assembly (“applicator”) includes a housing that encloses or supports (collectively “encloses”) the features of the applicator are described below. The housing includes a body having a first end and a second end. In some, embodiments, the housing will also include a handle that may be integral with the housing. By integral is meant that the component parts are formed together as a single unit. The assembly may include a cartridge releasably attached to either the first or second end of the housing.

The applicator includes one or more data operators (“operator”) functionally connected to the applicator. A data operator can be a hardware device, software application(s), or combination thereof. functionally connected is meant that a component or device is connected either directly or indirectly to a second component and causes that second component to function. For example, as described below, a data operator, such as an app is connected to the applicator assembly by hardwire or wireless such as 4G, LTE, 5G, WiFi®, Bluetooth®, etc., and causes the applicator to function in a prescribed manner. In another example, an action performed by the applicator causes data to be displayed in a data screen supported on the applicator. Examples of data operators include, but are not limited to, data screens, RFID antennas, RFID tags, computers, including laptops, smart phones, servers, and applications (“app”) or combinations thereof. For example, the data operator may be a hardware and/or software component that generates, processes, transmits, and/or receives data and may also control some subsequent action(s) of the applicator.

In an embodiment, the applicator supports a data screen visible to the user. The data screen may display data generated by the applicator and/or data received from the app. Examples of such data include, but are not limited to, name of product applied, number of doses of product applied, size of dose, and/or current battery strength, or any other desired piece of information.

RFID antennas are data operators that may be used to receive data such as type of bait or other product used from RFID tags accompanying individual product cartridges. This identification data may be transmitted to a data operator such as an app, a mobile computing device such as a smart phone or laptop and then further transmitted to a second computer or server for storage or further action. The RFID antenna(s) may receive or transmit additional data that may be generated by the applicator such as number of doses applied and dosage strength.

The applicator includes a dispensing force supported or enclosed by the housing. The dispensing force may be mechanically operated such as by, but not limited to, a spring under tension, a push rod similar to a mechanical caulking gun, or a threaded rod. Alternatively, the dispensing force may be a motor, such as but not limited to, a stepper motor. The dispensing force (“force”) may be operatively attached to a dispensing device such as but not limited to, a rod, a plunger assembly, threaded rod, pump, or other device functionally connected to a product cartridge and arranged to push or draw product from the cartridge onto a target. One functional connection may be the contacting of the cartridge by the dispensing device.

The applicator may include a dispensing switch that is operatively attached to the dispensing force to start or enable the dispensing force to activate the dispensing device to dispense the product from the cartridge. The dispensing switch may be a push button, a lever or other mechanical device or it may be a button or trigger electrically connected to the dispensing force, for example a motor. By electrically connected is meant the dispensing switch is connected directly or indirectly to the dispensing force via electrical wires or one or more circuit boards. In addition, an electrical power source, such as a battery, battery pack, electrical cord, or the like will be electrically connected to the applicator.

An embodiment of the applicator is described below along with the accompanying figures.

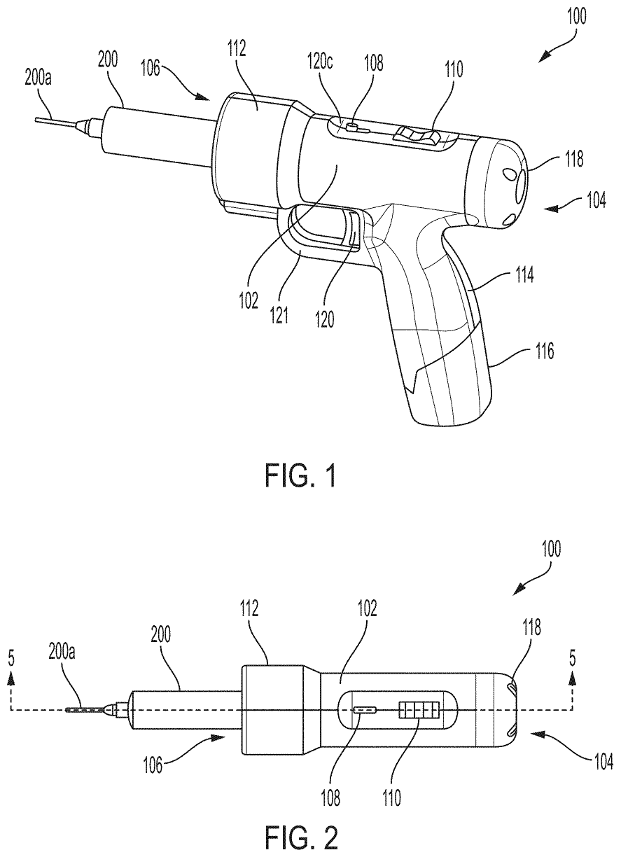

FIG. 1 is a side perspective view of bait applicator 100 (“applicator 100”). Housing 102 encloses the interior components of applicator 100 as will be discussed below. Back end 104 is opposite front end 106. Attached to back end 104 is stepper motor cover 118. Power (on/off) switch 108 and load/unload switch 110 extend above the top surface 102c of housing 102. A data operator in the form of an RFID antenna 112 (“antenna 112”) is depicted as attached to applicator 100 at second end 106 and surrounds second end 106. Cartridge 200 which includes a syringe-like nose 200a is releasably attached to second end 106 and extends therefrom. However, persons of skill in the art will recognize that antenna 112 may be any suitable shape and may be attached to applicator 100 at any appropriate location on applicator 100.

Handle 114 extends from proximate first end 104 to form a gun-like handle configuration. Bottom section 116 forms the bottom of handle 114 and may be releasably attached to the upper portion of handle 114. Alternatively, a dispensing switch in the form of trigger 120 is in a trigger-like arrangement with handle 114 and the upper portion of housing 102. Trigger guard 121 and the bottom of housing 102 surround trigger 120.

Applicator 100 may be controlled by a data operator in the form of an app running on a mobile data operator such as a laptop computer, digital pad, mobile phone or similar data operators known to those skilled in the art. The app receives data such as, but not limited to type of bait, number of doses delivered, location of target, and other relevant information and transmits it to a server or other microprocessor. This data may be manually entered by the user or automatically received from a data operator such as antenna 112 as described below.

FIG. 2 is a top view of applicator 100 showing power switch 108 and load/unload switch 110. Cartridge 200 with nozzle 200a extends from front end 106. In the depicted embodiment, RFID antenna 112 is seen surrounding cartridge 200 at front end 106. However, persons of skill in the art will recognize that antenna 112 may be positioned in any location on applicator 100.

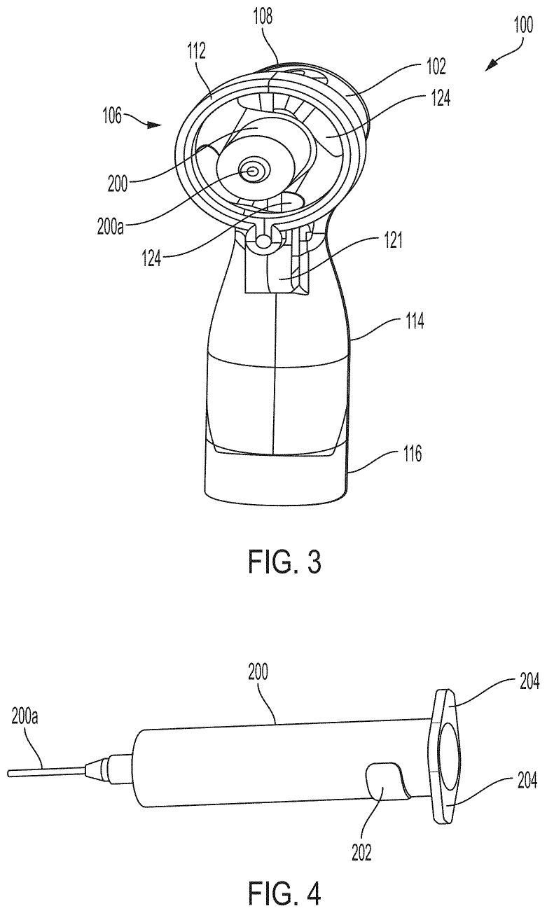

FIG. 3 is a front view of applicator 100 with cartridge 200 releasably attached to applicator 100 at front end 106. It can be seen more clearly that in the embodiment shown, antenna 112 surrounds both front end 106 and the proximal or back end of cartridge 200. Nozzle 200a extends from cartridge 200. Tabs 124 hold cartridge 200 in a releasable manner at end 106.

FIG. 4 is a side view of cartridge 200 showing RFID tag 202 (“tag 202”) and retaining means 204. Retaining tabs 204 (“tabs 204”) are positioned opposite each other on the back end of cartridge 200. In the embodiment shown, cartridge 200 is releasably attached to front end 106 of applicator 100 by inserting tabs 204 between applicator tabs 124 and then turning cartridge 200 so that retaining tabs 204 are behind applicator tabs 124 thereby releasably attaching cartridge 200 to applicator 100. To detach cartridge 200, it is turned to place retaining tabs 204 between applicator tabs 124 to allow cartridge 200 to be out of from applicator 100. Other releasable retaining means may be used such as, but not limited to, threads and spring-loaded sockets.

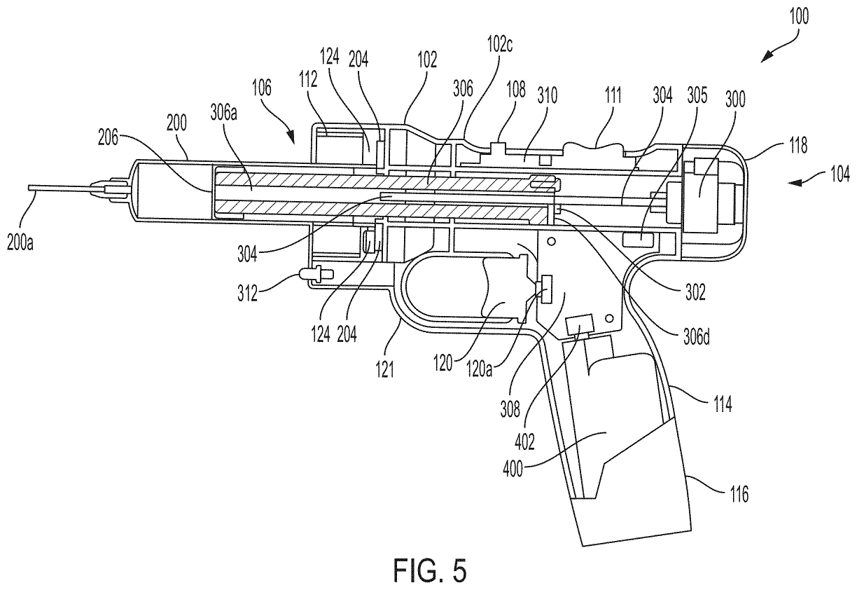

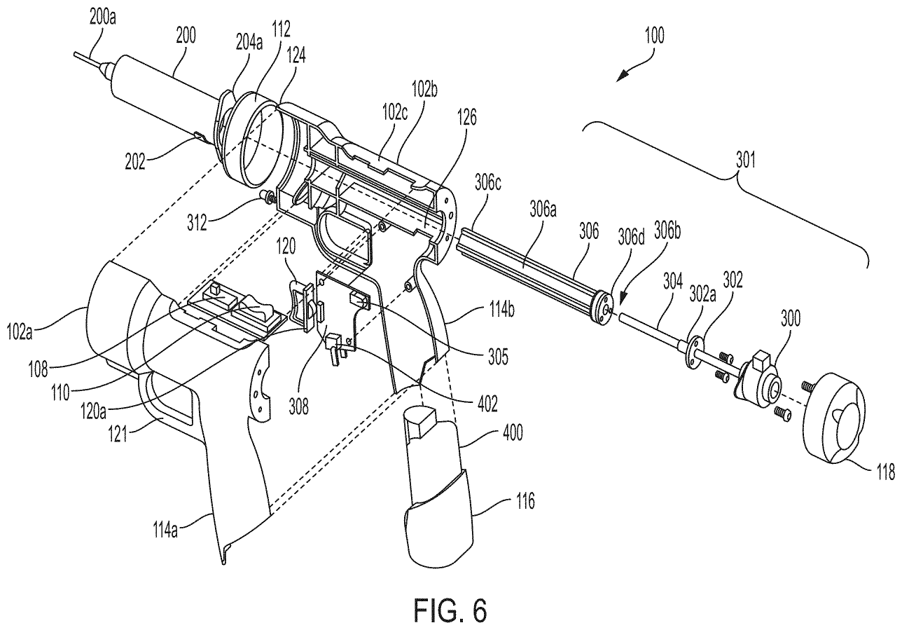

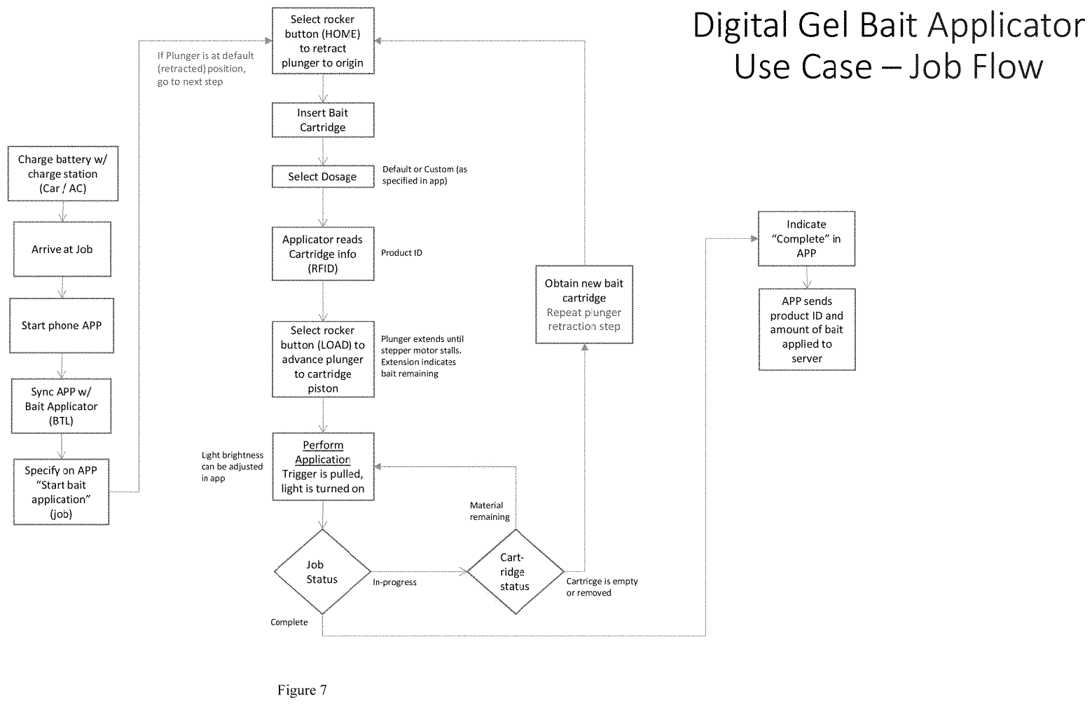

FIG. 5 is a cross section view of applicator 100 taken along line 5-5 in FIG. 2. A dispensing force in the form of a stepper motor 300 is operatively attached to a dispensing device in the form of a plunger assembly 301. See FIG. 6. By operatively attached is meant that a component or device is connected either directly or indirectly to a second component and causes that second component to function. Stepper motor 300 is covered by stepper motor cover 118 (“cover 118”) at back end 104. A dispensing device in the form of a plunger assembly 301 includes plunger nut 302, lead screw 304, and plunger 306. Plunger nut 302 is engaged with lead screw 304. The rear end of lead screw 304 is attached to stepper motor 300 and turns as stepper motor 300 rotates when it receives power. Lead screw 304 extends past plunger nut 302 into plunger channel 306a (“channel 306a”) with plunger nut 302 fastened to plunger cap 306d at the back end of plunger 306. Plunger 306 forms a sleeve around channel 306a. Plunger 306 contacts floating piston 206 at the rear end of cartridge 200.

In the cross-section view provided in FIG. 5, retaining tabs 204 on cartridge 200 fit behind tabs 124. Optional aiming light 312 fits under RFID antenna 112 and guides the user to aim applicator 100 by illuminating the target area. In one embodiment, aiming light 312 is an LED light. It will be recognized that aiming light 312 may be mounted on applicator 100 in other suitable locations on applicator 100 and with antenna 112 removed from applicator 100.

Electrical connections in the form of at least one circuit board are used to electrically connect trigger 120, power switch 108, load/unload switch 110, stepper motor 300, home switch 304 and aiming light 312 to a power source in the form of battery pack 400. Battery pack 400 is stored in handle 114. In one embodiment, bottom section 116 is removable from the upper portion of handle 114 allowing battery pack 400 to be replaced. In an alternate embodiment (not shown), battery pack 400 may be recharged while in place within handle 114. In a preferred embodiment, battery pack 400 forms handle 114 and is rechargeable. In the embodiment shown, applicator 100 includes circuit boards 310 and 308. Persons of skill in the art will recognize that one or more than two circuit boards may be used to electrically connect the appropriate components to battery pack 400.

Circuit board 308 supports contacts trigger 120 through trigger switch 120a which is mounted on circuit board 308. Home switch 304 is also mounted on circuit board 308. Power switch 108 and load/unload switch 110 is mounted on circuit board 310. Although not seen for circuit board 310, persons of skill in the art will recognize that all circuit boards are electrically connected directly or indirectly to battery pack 400 in order to receive power.

FIG. 6 is an exploded top perspective view of applicator 100. FIG. 6 depicts the embodiment in which housing 102 is formed by the fixedly attaching together housing half sections 102a and 102b. The joining of half sections 102a and 102b also form plunger passage 126 through which plunger 306 extends. It can be seen that lead screw 304 extends from stepper motor 300 and into plunger channel 306a. Plunger nut 302 is attached to lead screw 304 and is attached to the back end 306b of plunger 306. Plunger nut shaft 302a is seen inserted into plunger channel 306a as seen also in FIG. 5. Although not shown, motor 300 receives power from battery pack 400 through either circuit board 308 and/or circuit board 310. As seen in FIG. 5, front end 306c of plunger 306 contacts the back end of cartridge 200. Battery pack 400 may be charged with a car charger, an AC outlet, computer connection, or other methods known to in the art.

To operate applicator 100, a user will first turn on power button and place load/unload control button 110 in the load position. In the load position, motor 300 will rotate to push plunger assembly 301 toward and into contact with piston 206. In one embodiment, motor 300 rotates slightly in the opposite direction to back off plunger assembly 301 to prevent back pressure from forming in the cartridge. In a preferred embodiment, the amount of extension of plunger 306 to contact with piston 206 is recorded by the app and the distance converted into the amount of product remaining in cartridge 200. In the unload position, motor 300 rotates in the opposite direction to pull plunger assembly 301 away from piston 206. Piston 206 will remain in its new position. When trigger 120 is pulled back toward handle 114, it activates trigger switch 120a on circuit board 308. Board 308 sends power to stepper motor 300 to rotate a predetermined distance thereby rotating lead screw 304. In a preferred embodiment, trigger 120 is an “on” switch that starts motor 300 rotating, while the app controls how long motor 300 operates thereby controlling the product dosage dispensed by applicator 100. The rotation of lead screw 304 and attached plunger nut 302 causes plunger 306 to be pushed laterally into the back end of cartridge 200 pushing the bait product, such as gel-bait product, out of nose 200a. In a preferred embodiment, aiming light 312 is turned on with the activation of trigger 120 and illuminates the target area.

Because stepper motors do not rotate continuously but rather turn in small increments based on length of time power is received by the motor, the use of a stepper motor such as stepper motor 300 provides the advantage of allowing for delivery of more precise quantities of bait to the target than a continuously rotating motor. The app may be used to control the length of time power is delivered to stepper motor 300.

In one embodiment, load/unload switch 110 returns lead screw 304 to the home or starting position.

RFID antenna 112 reads the identity of the bait from RFID tag 202 and communicates this information to an app on a mobile phone or portable device such as a laptop computer or computer mounted on a truck. Alternatively, the information may be manually entered into the app. The app can store this information for retrieval when convenient. In an alternate embodiment (not shown), a display window on applicator 100 that is linked to the app may display not only cartridge information but also additional information, such as but not limited to, battery pack life, product dispensed, product identification, how many times the trigger is pulled, job site location, and dosage.

The use of external cartridge 200 with applicator 100 has advantages in that it is easy to replace an empty cartridge with a full one. A distinct advantage of this easily interchanged cartridge is that the applicator can readily switch between product, either between unique services or within the same service. The ability to easily switch products is a feature of importance in integrated pest resistance management programs. Other advantages include that it is easier to use than other applicators in the field, as it is not tethered to a power or product line, and a known quantity of product may be ejected with each turn of motor 300, which reduces overuse of the product.

The app itself is preferably included in a portable data operator such as a mobile phone, laptop computer, or a computer mounted in a truck or other vehicle. Communication between the app and applicator 100 can be by hardwire or wireless transmission such as 4G, LTE, 5G, WiFi®, Bluetooth®, etc. The app can also be situated in a location away from the job, such as in an office with communication by satellite or cellular transmission. In either embodiment, the app and applicator 100 communicate and generate data and commands, such as but not limited to, control of the dosage applied to a target, recording the amount of product remaining in cartridge 200, identifying the product in cartridge 200, the number of pulls on trigger 120, the time and date of the application, battery life, and the location of the target, e.g. the global positioning system (gps) location. The app stores this data until it is sent to a server where it is stored.

FIG. 7 is a flow diagram depicting the method of operation of applicator 100. Upon arrival at a job location, the app is activated and synchronized with bait applicator 100. To start, the “start bait application” instruction is activated. If plunger assembly 301 is in the retracted or default position, cartridge 200 is inserted into front end 106 of applicator 100 and a dosage is selected. The dose may be a default dosage or a custom dose specified and controlled by the app. Applicator 100 reads the information, such as product identification. The load option load/unload button 110 is selected which extends plunger assembly 301 until stepper motor 300 stalls when plunger 306 contacts piston 206. The extension distance is measured by the app and using this distance the app calculates the amount of bait left in cartridge 200. Trigger 120 is pulled which starts motor 300 rotating to push the required dosage out nozzle 200a. If the job is not completed trigger 120 is pulled repeatedly until the job is completed. When the job is completed, the app, which has been recording the amount of product dispensed, indicates the job is complete and transmits the product ID and amount of product applied to the server.

If cartridge 200 is emptied before the job is completed, home button 310 or the unload option on load/unload button 110 is pressed to retract plunger assembly 301 to the default or home position, the empty cartridge is replaced and the app records the product identification and quantity of product in replacement cartridge 200. As noted above, this information can be gathered by RFID antenna 112 reading tag 202 and transmitting it to the app.

Thus, it is seen that the objects of the invention are efficiently obtained, although changes and modifications to the invention should be readily apparent to those having ordinary skill in the art, which changes would not depart from the spirit and scope of the invention as claimed.

1. A product applicator comprising:
a housing having a first end and a second end;
a dispensing force;
a dispensing device operatively attached to the dispensing force;
at least one power source;
a dispensing switch operatively attached to the dispensing force; and,
at least one data operator electrically connected to an electrical power source.

2. The applicator of claim 1 further comprising a product cartridge releasably attached to the housing.

3. The applicator of claim 1 wherein the at least one data operator is chosen from an app, a data screen, a dispensing switch, an on/off switch, an RFID antenna, an RFID tag, a computer, a server, a smart phone, a laptop, or any combination thereof.

4. The applicator of claim 1 wherein the dispensing device is operatively connected to the product cartridge.

5. The gel bait applicator according to claim 1 further comprising:
at least one circuit board;
a load/unload switch;
an on/off switch supported on said at least one circuit board;
a dispensing trigger supported by said at least one circuit board and operatively attached to said dispensing device; and,
a battery pack electrically connected to said first circuit board;
wherein said applicator is controlled by a first data operator in the form of an app running on a mobile device;
wherein the housing further comprises a handle;
wherein the dispensing force is a stepper motor;
wherein the dispensing device is a plunger assembly operatively attached to said stepper motor;
wherein the dispensing switch is a trigger supported by said at least one circuit board; and.
wherein the power source is a battery pack electrically connected to said at least one circuit board.

6. The gel bait applicator of claim 1 further comprising a second data operator in the form of an RFID antenna functionally attached to said applicator.

7. The gel bait applicator of claim 1 further comprising a cartridge releasably attached to said applicator; wherein said cartridge includes a third data operator in the form of an RFID tag.

8. The gel bait applicator of claim 1 wherein said RFID antenna reads said RFID tag.

9. The gel bait applicator of claim 1 further comprising an aiming light.

10. The gel bait applicator of claim 5 wherein said plunger assembly includes
a plunger;
a plunger nut attached to plunger; and,
a lead screw attached to said stepper motor and attached to said plunger nut;
wherein said lead screw extends into said plunger.

11. The gel bait applicator of claim 1 further comprising a data screen mounted on said applicator and configured to display data received from said app.

12. A method of applying a product onto a target using the applicator of claim 1, comprising:
releasably attaching a cartridge onto the applicator assembly;
activating the dispensing switch to activate the dispensing force;
moving the dispensing device into the cartridge;
ejecting the product toward the target; and,
recording an application of said product one said target by at least one of said data operator.

13. A method of applying a product onto a target using the applicator of claim 5,
comprising:
synchronizing said app with said applicator;
releasably attaching a cartridge onto said applicator wherein said cartridge contains a bait product;
recording cartridge information into said app;
extending said plunger to said cartridge using a load mode on said load/unload button;
recording a remaining quantity of said bait product in said cartridge;
aiming the first end of said applicator toward a target;
pulling the trigger of said applicator;
activating the stepper motor of the applicator;
pushing the plunger assembly toward the attached cartridge; and
ejecting said bait product toward said target.

14. The method of claim 12 further comprising repeating said recording, aiming, pulling activating, pushing and ejecting.

15. The method of claim 12 further comprising indicating a job complete status via said app.

16. The method of claim 12 further comprising illuminating said target with an aiming light.

17. The method of claim 12 further comprising transmitting a bait identification data and amount of said bait product applied to a server via said app.
